(19) United States
(12) Patent Application Publication
(10) Pub. No.: US 2025/0070354 A1
(43) Pub. Date: Feb. 27, 2025

(54) BATTERY MODULE AND BATTERY PACK

(71) Applicant: TOYOTA JIDOSHA KABUSHIKI KAISHA, Toyota-shi (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 18/775,481

(22) Filed: Jul. 17, 2024

(30) Foreign Application Priority Data
Aug. 25, 2023 (JP) 2023-137299

(51) Int. Cl. H01M 50/242; H01M 50/249; H01M 50/291

(52) U.S. Cl. CPC H01M 50/242; H01M 50/291; H01M 50/249

(57) ABSTRACT

A battery module includes: a plurality of battery cells housed in an arrayed state inside a case; and a buffer member that is disposed at least one of between adjacent battery cells and between the battery cells and an inner wall of the case such that its thickness direction coincides with the array direction of the battery cells and is formed in such a way that a reaction force acting on the battery cells is smaller at its central portion than at its peripheral end portion.

### CROSS-REFERENCE TO RELATED APPLICATION

This application is based on and claims priority under 35 USC 119 from Japanese Patent Application No. 2023-137299, filed on Aug. 25, 2023, the disclosure of which is incorporated by reference herein.

### BACKGROUND

### Technical Field

The present disclosure relates to a battery module and a battery pack.

### Related Art

Japanese Patent Application Laid-open (JP-A) No. 2009-163932 discloses a battery pack where heat-insulating buffers members are disposed between stacked battery cells. In the battery pack disclosed in JP-A No. 2009-163932, by disposing the heat-insulating buffer members between the battery cells, the battery cells can be inhibited from directly rubbing against each other when products are transported, and the battery cells can be thermally insulated from each other.

In this connection, in order to improve the amount of stored charge per unit area of a battery module, it is necessary to array the battery cells without leaving a gap between them, but in the battery pack of JP-A No. 2009-163932, thermal expansion of the battery cells cannot be absorbed. In particular, the central parts of the battery cells swell in their thickness direction during thermal expansion, but in the battery pack of JP-A No. 2009-163932 such thermal expansion of the battery cells is not considered, and there is room for improvement.

### SUMMARY

In consideration of the above circumstances, it is an object of the present disclosure to obtain a battery module and a battery pack that can absorb the thermal expansion of the battery cells.

A battery module of a first aspect includes: a plurality of battery cells housed in an arrayed state inside a case; and a buffer member that is disposed at least one of between adjacent battery cells or between the battery cells and an inner wall of the case such that a thickness direction of the buffer member coincides with an array direction of the battery cells, and that is formed in such a way that a reaction force acting on the battery cells is smaller at a central portion of the buffer member than at a peripheral end portion thereof.

In the battery module of the first aspect, the plurality of battery cells are housed in an arrayed state inside the case. Furthermore, the buffer member is disposed at least one of between adjacent battery cells and between the battery cells and an inner wall of the case. Here, the thickness direction of the buffer member coincides with the array direction of the battery cells, and the buffer member is formed in such a way that the reaction force acting on the battery cells is smaller at its central portion than at its peripheral end portion. Because of this, when the battery cells thermally expand and the central parts of the battery cells swell, the reaction force acting on the battery cells from the buffer member can be made substantially uniform at the central portion and the peripheral end portion, and the thermal expansion of the battery cells can be absorbed by the buffer member.

A battery module of a second aspect is the first aspect, wherein the buffer member is at least disposed at a central part of the case in the array direction of the battery cells.

In the battery module of the second aspect, by disposing the buffer member in the central part of the case in the array direction of the battery cells, where stress acts the most due to thermal expansion of the battery cells, the thermal expansion of the battery cells in the battery module overall can be effectively absorbed.

A battery module of a third aspect is the first aspect, wherein the buffer member is formed such that a thickness of a central portion thereof is thinner than that of a peripheral end portion thereof.

In the battery module of the third aspect, by making the thickness of the central portion of the buffer member thinner than that of the peripheral end portion, the reaction force acting on the battery cells from the central portion of the buffer member can be made smaller than the reaction force acting on the battery cells from the peripheral end portion of the buffer member.

A battery module of a fourth aspect is the first aspect, wherein the buffer member is formed such that a density of a central portion thereof is smaller than that of a peripheral end portion thereof.

In the battery module of the fourth aspect, by making the density of the central portion of the buffer member smaller than that of the peripheral end portion, the reaction force acting on the battery cells from the central portion of the buffer member can be made smaller than the reaction force acting on the battery cells from the peripheral end portion of the buffer member.

A battery module of a fifth aspect is the first aspect, wherein the buffer member is disposed at least between inner walls on both sides of the case and the battery cells.

In the battery module of the fifth aspect, by disposing the buffer member between the inner walls on both sides of the case and the battery cells, the reaction force acting on the battery cells from the inner walls of the case can be reduced.

A battery module of a sixth aspect is the fifth aspect, wherein a central thick buffer member is disposed at a central part of the case in the array direction of the battery cells, the central thick buffer member being formed such that a thickness of a central portion thereof is thicker than that of a peripheral end portion thereof.

In the battery module of the sixth aspect, thermal expansion is absorbed by the buffer members disposed between the inner walls on both sides of the case and the battery cells, and at the same time the central parts of the battery cells are caused to curve by the central thick buffer member disposed in the central part of the battery module in the array direction of the battery cells. Because of this, terminals extending from end portions of the battery cells can be bent toward the central side in the array direction of the battery cells, and stress can be inhibited from concentrating in the terminals.

A battery pack of a seventh aspect includes a plurality of the battery modules of any one of the first aspect to the sixth aspect.

In the battery pack of the seventh aspect, by absorbing thermal expansion of the battery cells in the plural battery modules, the reliability of the battery pack overall can be improved.

As described above, according to the battery module and the battery pack pertaining to the present disclosure, the thermal expansion of the battery cells can be absorbed.

### BRIEF DESCRIPTION OF THE DRAWINGS

Exemplary embodiments of the present disclosure will be described in detail based on the following figures, wherein:

FIG. 1 is a schematic plan view showing main parts of a vehicle to which a battery pack pertaining to a first embodiment has been applied;

FIG. 2 is a schematic perspective view of a battery module;

FIG. 3 is a plan view of the battery module in a state in which a top cover is removed;

FIG. 4 is a schematic view of a battery cell housed in the battery module as seen from its thickness direction;

FIG. 5 is a schematic perspective view showing main parts of the battery module in the first embodiment;

FIG. 6 is a schematic view of a buffer member in the first embodiment as seen from its thickness direction;

FIG. 7 is a schematic plan view of battery cells and buffer members in the first embodiment;

FIG. 8 is a view schematically showing a state in which the battery cells have thermally expanded from the state shown in FIG. 7;

FIG. 9 is a schematic plan view of battery cells and buffer members in a second embodiment; and

FIG. 10 is a view schematically showing a state in which the battery cells have thermally expanded from the state shown in FIG. 9.

### DETAILED DESCRIPTION

### First Embodiment

A battery pack 10 and a battery module 11 pertaining to a first embodiment will now be described with reference to the drawings.

### (Overall Configuration of Vehicle 100)

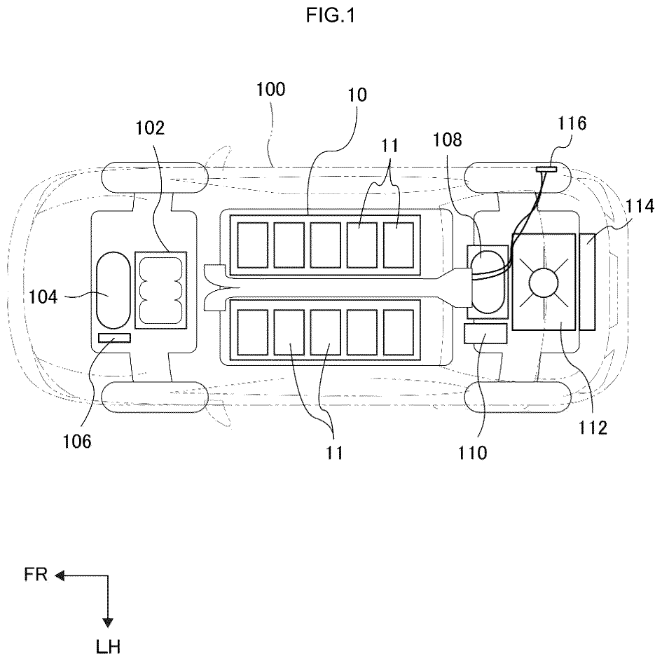

FIG. 1 is a schematic plan view showing main parts of a vehicle 100 to which the battery pack 10 pertaining to the embodiment has been applied. As shown in FIG. 1, the vehicle 100 is a battery electric vehicle (BEV) where the battery pack 10 is installed under the floor. It will be noted that arrow UP, arrow FR, and arrow LH in the drawings indicate an upward direction in the vehicle up and down direction, a forward direction in the vehicle front and rear direction, and a leftward direction in the vehicle width direction, respectively. When description is given using the directions of front/rear, left/right, and upper/lower, unless otherwise specified these shall mean front/rear in the vehicle front and rear direction, left/right in the vehicle width direction, and upper/lower in the vehicle up and down direction.

In the vehicle 100 of the present embodiment, as an example, a DC/DC converter 102, an electric compressor 104, and a positive temperature coefficient (PTC) heater 106 are disposed on the vehicle front side of the battery pack 10. Furthermore, on the vehicle rear side of the battery pack 10, a motor 108, a gearbox 110, an inverter 112, and a charger 114 are disposed.

Direct current output from the battery pack 10 has its voltage regulated by the DC/DC converter 102 and is thereafter supplied to the electric compressor 104, the PTC heater 106, the inverter 112, and elsewhere. Furthermore, power is supplied via the inverter 112 to the motor 108, whereby rear wheels rotate and cause the vehicle 100 to travel.

A charging port 116 is provided in the right side portion of the rear portion of the vehicle 100. By connecting a charging plug of an outside charging station (not shown in the drawings) to the charging port 116, power can be stored in the battery pack 10 via the on-board charger 114.

It will be noted that the arrangement and structures of the parts configuring the vehicle 100 are not limited to the configurations described above. For example, the battery pack 10 may also be applied to a hybrid vehicle (HV) or a plug-in hybrid electric vehicle (PHEV) where an engine is installed. Furthermore, in the present embodiment, the vehicle to which the battery pack 10 is applied is a rear-wheel-drive vehicle where the motor 108 is installed in the rear portion of the vehicle, but the vehicle to which the battery pack 10 is applied is not limited to this and may be a front-wheel-drive vehicle where the motor 108 is installed in the front portion of the vehicle or a vehicle where a pair of the motors 108 are installed in the front and rear of the vehicle. Moreover, the vehicle to which the battery pack 10 is applied may be a vehicle where each wheel has an in-wheel motor.

Here, the battery pack 10 is configured to include a plurality of the battery modules 11. In the present embodiment, as an example, the battery pack 10 is provided with ten battery modules 11. Specifically, five battery modules 11 are arrayed in the vehicle front and rear direction on the right side of the vehicle 100, and five battery modules 11 are arrayed in the vehicle front and rear direction on the left side of the vehicle 100. Furthermore, the battery modules 11 are electrically interconnected.

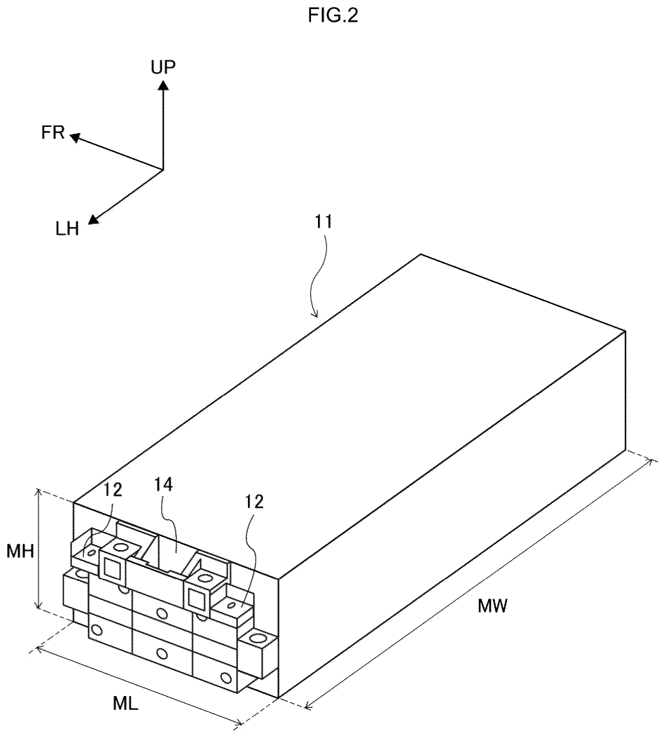

FIG. 2 is a schematic perspective view of the battery module 11. As shown in FIG. 2, the battery module 11 is formed substantially in the shape of a rectangular cuboid whose lengthwise direction coincides with the vehicle width direction. Furthermore, a shell of the battery module 11 is formed of an aluminum alloy. For example, the shell of the battery module 11 is formed by joining, by laser welding or the like, aluminum die casts to both end portions of an extruded material of aluminum alloy.

Both vehicle width direction end portions of the battery module 11 are provided with a pair of voltage terminals 12 and a connector 14. To the connectors 14 are connected a flexible printed circuit 21 described later. Furthermore, busbars (not shown in the drawings) are welded to both vehicle width direction end portions of the battery module 11.

The battery module 11 has a vehicle width direction length MW that is 350 mm to 600 mm for example, a vehicle front and rear direction length ML that is 150 mm to 250 mm for example, and a vehicle up and down direction height MH that is 80 mm to 110 mm for example.

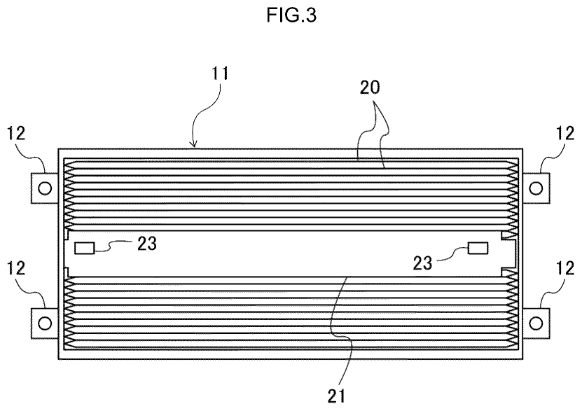

FIG. 3 is a plan view of the battery module 11 in a state in which a top cover is removed. As shown in FIG. 3, inside the battery module 11 a plurality of battery cells 20 are housed in an arrayed state. In the present embodiment, as an example, twenty-four battery cells 20 are arrayed in the vehicle front and rear direction and adhered to each other.

On the battery cells 20 is disposed a flexible printed circuit (FPC) 21. The flexible printed circuit 21 is formed in the shape of a band whose lengthwise direction coincides with the vehicle width direction, and thermistors 23 are provided on both end portions of the flexible printed circuit 21. The thermistors 23 are not adhered to the battery cells 20 but are configured to be pressed toward the battery cells 20 by the top cover of the battery module 11.

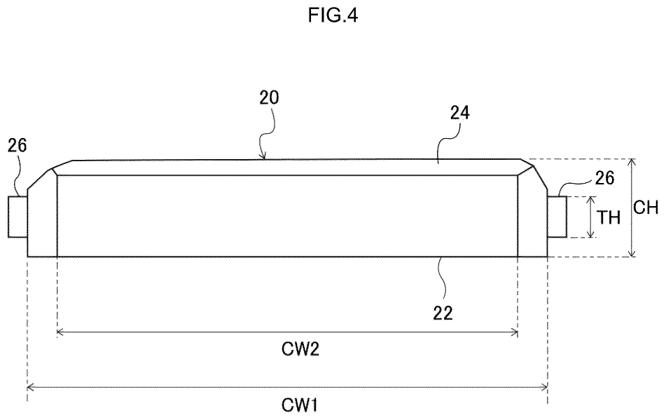

FIG. 4 is a schematic view of the battery cell 20 housed in the battery module 11 as seen from its thickness direction. As shown in FIG. 4, the battery cell 20 is formed substantially in the shape of a rectangular plate, and an electrode body (not shown in the drawings) is housed inside. The electrode body is configured by laminating positive electrodes, negative electrodes, and separators and is sealed by a laminate film 22.

In the present embodiment, as an example, a housing portion of the electrode body is formed by folding over and bonding the laminate film 22 that is sheet-like and embossed. It will be noted that although a single cup embossed structure that is embossed in one place and a double cup embossed structure that is embossed in two places can be employed, in the present embodiment a single cup embossed structure with a draw depth of about 8 mm to 10 mm is employed.

The upper ends of both lengthwise direction end portions of the battery cell 20 are bent, and the corners form the profile. Furthermore, the upper end portion of the battery cell 20 is bent, and a fixing tape 24 is wrapped along the lengthwise direction around the upper end portion of the battery cell 20.

Here, both lengthwise direction end portions of the battery cell 20 are each provided with a tab 26. In the present embodiment, as an example, the tabs 26 are provided in positions downwardly offset from the up and down direction center of the battery cell 20. The tabs 26 are joined by laser welding or the like to busbars (not shown in the drawings).

A vehicle width direction length CW1 of the battery cell 20 is, for example, 530 mm to 600 mm, 600 mm to 700 mm, 700 mm to 800 mm, 800 mm to 900 mm, or 1000 mm or more, a length CW2 of the region where the electrode body is housed is, for example, 500 mm to 520 mm, 600 mm to 700 mm, 700 mm to 800 mm, 800 mm to 900 mm, or 1000 mm or more, and a height CH of the battery cell 20 is, for example, 80 mm to 110 mm or 110 mm to 140 mm. Furthermore, the thickness of the battery cell 20 is 5.0 mm to 7.0 mm, 7.0 mm to 9.0 mm, or 9.0 mm to 11.0 mm, and a height TH of the tabs 26 is 40 mm to 50 mm, 50 mm to 60 mm, or 60 mm to 70 mm.

### (Buffer Members 32, 34)

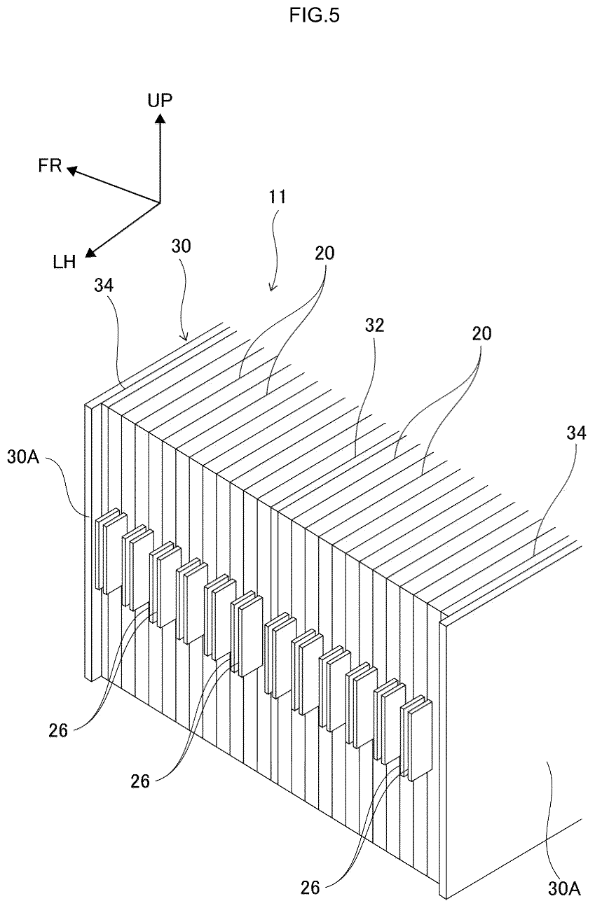

FIG. 5 is a schematic perspective view showing main parts of the battery module 11 of the embodiment. As shown in FIG. 5, the twenty-four battery cells 20 are housed without any gap between them in a state in which they are arrayed in the vehicle front and rear direction in a module case 30 serving as a case configuring the battery module 11.

Furthermore, inside the battery case 30, one or plural buffers are housed. In the present embodiment, as an example, a total of three buffers, one buffer member 32 and two buffer members 34, are housed inside the module case 30.

The buffer member 32 is disposed between adjacent battery cells 20 such that its thickness direction coincides with the array direction of the battery cells 20 (the vehicle front and rear direction) and is formed of a thin plate-like member that is elastically deformable. In particular, the buffer member 32 is disposed in the vehicle front and rear direction central part of the module case 30. In the present embodiment, as an example, twelve battery cells 20 are disposed on the vehicle front side of the buffer member 32, and twelve battery cells 20 are disposed on the vehicle rear side of the buffer member 32. For this reason, the buffer member 32 is disposed in a position that equally divides the arrayed plurality of battery cells 20.

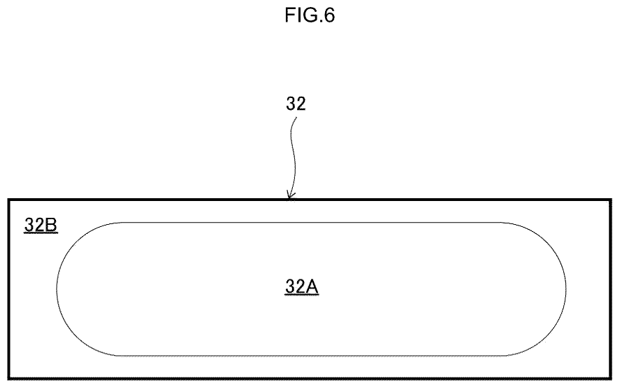

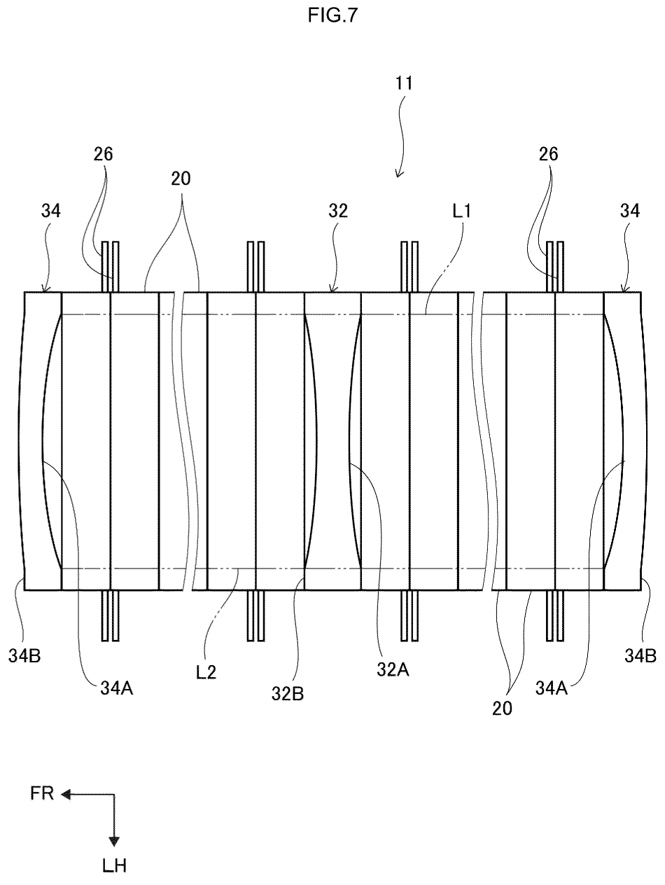

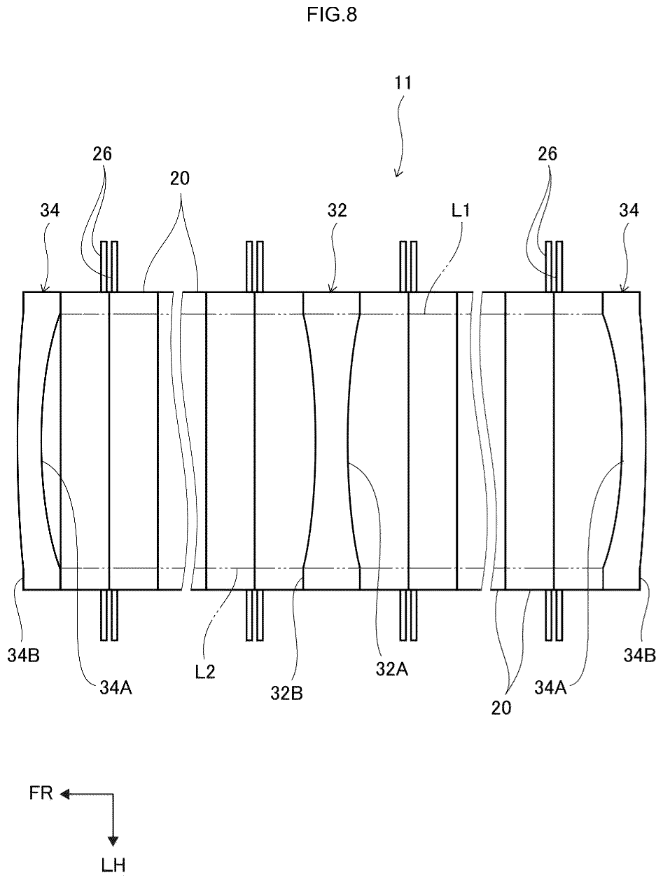

FIG. 6 is a schematic view of the buffer member 32 in the embodiment as seen from its thickness direction. Furthermore, FIG. 7 is a schematic plan view of the battery cells 20 and the buffer members 32, 34 in the embodiment. As shown in FIG. 6 and FIG. 7, the buffer member 32 of the present embodiment is formed such that the thickness of its central portion 32A is thinner than that of its peripheral end portion 32B. In other words, the buffer member 32 is formed in such a way that the reaction force acting on the battery cells 20 is smaller at its central portion 32A than at its peripheral end portion 32B. It will be noted that in FIG. 7, for convenience of description, the lengthwise direction lengths of the battery cells 20, the buffer member 32, and the buffer members 34 are depicted short and the relationships between actual thicknesses and lengths are different. The same is also true of FIG. 8 to FIG. 10 described later.

The region of the central portion 32A of the buffer member 32 of the present embodiment is, as an example, formed substantially in the shape of a rectangle with semicircular ends as viewed from its thickness direction and is formed in a shape where its thickness gradually becomes thinner heading toward the center. It will be noted that the region of the central portion 32A of the buffer member 32 is not limited to this and may be substantially rectangular in shape or substantially oval in shape as viewed from its thickness direction. Furthermore, although the buffer member 32 is formed so as to have a substantially rectangular outer shape as seen from its thickness direction, it is not limited to this and may also be formed substantially in the shape of a rectangle with semicircular ends where the four corners are rounded.

Here, the central portion 32A of the buffer member 32 is the region between virtual line L1 and virtual line L2 in FIG. 7. The regions of the battery cells 20 between virtual line L1 and virtual line L2 correspond to active material coated regions where electrode active materials are coated.

As shown in FIG. 5, the two buffer members 34 are disposed between inner walls of side walls 30A on the front and rear sides of the module case 30 and the battery cells 20 such that their thickness direction coincides with the array direction of the battery cells 20, that is, the vehicle front and rear direction. For this reason, one face of each buffer member 34 has a battery cell 20 adhered to it and the other face of each buffer member 34 has a side wall 30A adhered to it.

The buffer members 34 have outer shapes that are substantially identical to that of the buffer member 32. Namely, the buffer members 34 of the present embodiment are each formed substantially in the shape of a rectangle as viewed from their thickness direction. Furthermore, as shown in FIG. 7, the buffer members 34 are formed such that the thickness of their central portions 34A is thinner than that of their peripheral end portions 34B. In other words, the buffer members 34 are formed in such a way that the reaction force acting on the battery cells 20 is smaller at their central portions 34A than at their peripheral end portions 34B.

The buffer member 34 positioned on the vehicle front side is formed in a shape where the central portion 34A of the face on the vehicle rear side, that is, the face on the side adjacent to the battery cells 20, is recessed in the vehicle forward direction and where its thickness gradually becomes thinner heading toward the center. Furthermore, the vehicle front-side face of that buffer member 34 is formed in a substantially planar shape along the inner wall (not shown in the drawings) of the module case 30.

Meanwhile, the buffer member 34 positioned on the vehicle rear side has a shape that is bilaterally symmetrical to that of the buffer member 34 positioned on the vehicle front side. Namely, the buffer member 34 positioned on the vehicle rear side is formed in a shape where the central portion 34A of the face on the vehicle front side, that is, the face on the side adjacent to the battery cells 20, is recessed in the vehicle rearward direction and where its thickness gradually becomes thinner heading toward the center. Furthermore, the vehicle rear-side face of that buffer member 34 is formed substantially in a planar shape along the inner wall (not shown in the drawings) of the module case 30. It will be noted that for convenience of description FIG. 7 exaggerates the difference in thickness between the central portion 32A and the peripheral end portion 32B of the buffer member 32 and the difference in thickness between the central portions 34A and the peripheral end portions 34B of the buffer members 34. In actuality, there are no gaps, or virtually no gaps, between the central portion 32A of the buffer member 32 and the battery cells 20. Likewise, in actuality, there are no gaps, or virtually no gaps, between the central portions 34A of the buffer members 34 and the battery cells 20.

FIG. 8 is a view schematically showing a state in which the battery cells 20, the buffer member 32, and the buffer members 34 are housed in the module case 30 and the battery cells 20 have thermally expanded. As shown FIG. 8, the battery cells 20 thermally expand due to repeated charging and discharging for example. In particular, the active material coated regions of the battery cells 20 thermally expand, and the central portions of the battery cells 20 swell outward.

Here, in the present embodiment, because the thickness of the central portion 32A of the buffer member 32 is thin, the central portions of the battery cells 20 enter the thinned portion, whereby the reaction force acting on the battery cells 20 from the buffer member 32 can be made the same extent at the central portion and the peripheral end portion. Likewise, because the thickness of the central portions 34A of the buffer members 34 is thin, the central portions of the battery cells 20 enter the thinned portions, whereby the reaction force acting on the battery cells 20 from the buffer members 34 can be made the same extent at the central portions and the peripheral end portions.

### (Operation)

Next, the operation of the battery module 11 and the battery pack 10 pertaining to the present embodiment will be described.

In the battery module 11 pertaining to the present embodiment, the plurality of battery cells 20 are housed in an arrayed state inside the module case 30. Furthermore, the buffer member 32 is disposed between adjacent battery cells 20, and the buffer members 34 are disposed between the battery cells 20 and the inner walls of the module case 30.

Here, the thickness direction of the buffer member 32 and the buffer members 34 coincides with the array direction of the battery cells, and the buffer member 32 and the buffer members 34 are formed in such a way that the reaction force acting on the battery cells 20 is smaller at the central portions 32A, 34A than at the peripheral end portions 32B, 34B of the buffer members 32, 34. Because of this, when the battery cells 20 thermally expand and the central parts of the battery cells 20 swell, the reaction force acting on the battery cells 20 from the buffer members 32, 34 can be made substantially uniform at the central portions and the peripheral end portions, and the thermal expansion of the battery cells 20 can be absorbed by the buffer members 32, 34.

Furthermore, due to the thermal expansion of the battery cells 20, stress acts the most in the front and rear direction central part of the battery module 11, so by disposing the buffer member 32 in the central part of the battery module 11, the thermal expansion of the battery cells 20 in the battery module 11 overall can be effectively absorbed.

Moreover, in the present embodiment, by making the thickness of the central portions 32A, 34A of the buffer members 32, 34 thinner than that of the peripheral end portions 32B, 34B, the reaction force acting on the battery cells 20 from the central portions 32A, 34A of the buffer members 32, 34 can be made smaller than the reaction force acting on the battery cells 20 from the peripheral end portions 32B, 34B of the buffer members 32, 34.

Moreover still, in the present embodiment, by disposing the buffer members 34 between the inner walls of the side walls 30A on both sides of the module case 30 and the battery cells 20, the reaction force acting on the battery cells 20 from the inner walls of the module case 30 can be reduced.

### Second Embodiment

Next, a battery module 50 pertaining to a second embodiment will be described with reference to the drawings. It will be noted that configurations that are the same as those of the first embodiment are assigned the same reference signs and description thereof is omitted as appropriate.

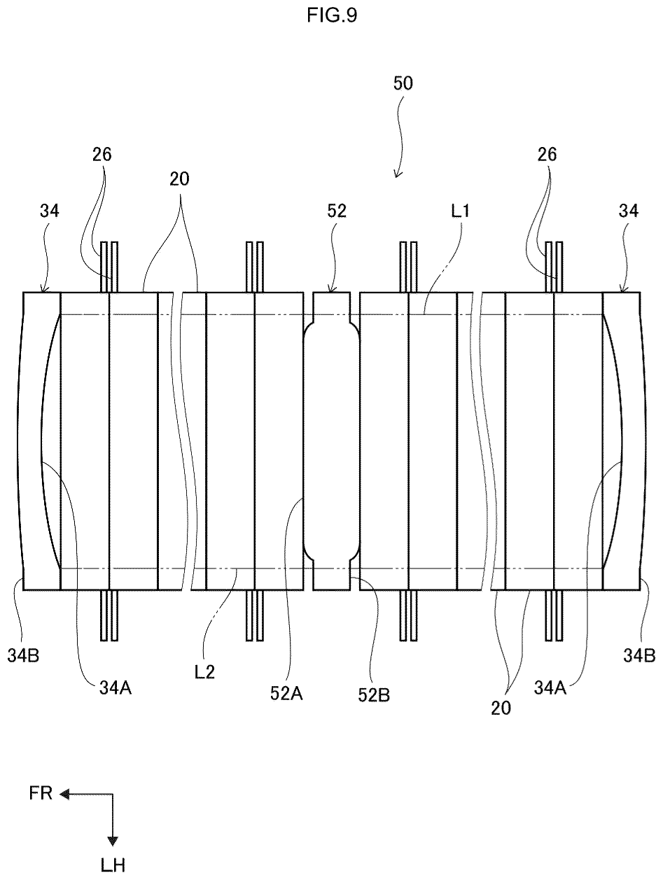

FIG. 9 is a schematic plan view of battery cells and buffer members in the second embodiment. As shown in FIG. 9, the battery module 50 of the present embodiment has the same structure as that of the first embodiment with the exception of a central thick buffer member 52.

The central thick buffer member 52 is disposed in the central part of the battery module 50 in the array direction of the battery cells 20 such that its thickness direction coincides with the array direction of the battery cells 20. Furthermore, the central thick buffer member 52 is formed so as to have a substantially rectangular outer shape as viewed from its thickness direction.

Here, the central thick buffer member 52 of the present embodiment is formed such that the thickness of its central portion 52A is thicker than that of its peripheral end portion 52B.

### (Operation)

Next, the operation of the battery module 50 pertaining to the present embodiment will be described.

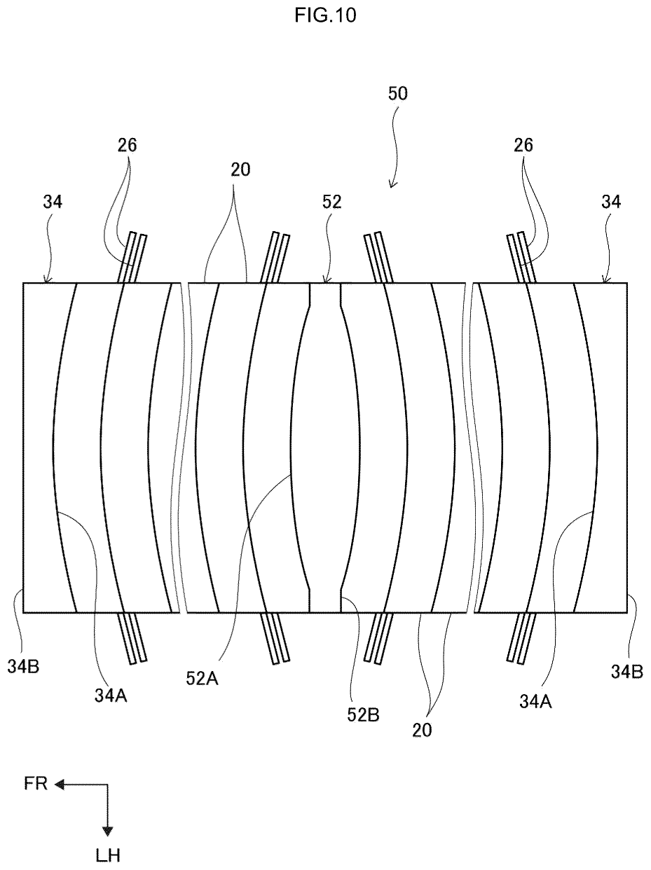

FIG. 10 is a view schematically showing a state in which the battery cells 20 have thermally expanded from the state shown in FIG. 9. As shown in FIG. 10, in the present embodiment, the thermal expansion of the battery cells 20 is absorbed by the buffer members 34 disposed on both front and rear sides of the battery module 50.

Furthermore, the central parts of the battery cells 20 are curved by the central thick buffer member 52 disposed in the vehicle front and rear direction central part of the battery module 50. Because of this, the tabs 26 extending from the end portions of the battery cells 20 can be bent toward the central side in the array direction of the battery cells 20, and stress can be inhibited from concentrating in the tabs 26.

Namely, if just the tabs 26 are bent, stress concentrates in the base portions of the tabs 26, and there is the potential for the tabs 26 to sustain damage, but by allowing the battery cells 20 themselves to curve as in the present embodiment, stress can be inhibited from concentrating in the base portions of the tabs 26. Other actions are the same as those of the first embodiment.

The battery pack 10 and the battery modules 11, 50 pertaining to the first and second embodiments have been described above, but the disclosure is not limited to this and can of course be implemented in various aspects without departing from the spirit of the disclosure. For example, in the first embodiment, as shown in FIG. 7, the buffer members 32, 34 are formed in shapes whose thickness gradually becomes thinner heading from the peripheral end portions 32B, 34B to the central portions 32A, 34A, but the shapes of the buffer members 32, 34 are not limited to this. For example, the buffer members 32, 34 may also have shapes with steps added so that their thickness becomes thinner in stages.

Furthermore, the buffer members 32, 34 are formed so that the central portions 32A, 34A are thinner in thickness than the peripheral end portions 32B, 34B, but the buffer members 32, 34 are not limited to this. As another aspect, buffer members formed such that the density of their central portions is smaller than that of their peripheral end portions may also be used. For example, in a case where the buffer members are formed of a foamed resin, the foaming amount may be controlled to form buffer members where the density of the central portions is smaller than that of the peripheral end portions. By making the density of the central portions of the buffer members smaller than that of the peripheral end portions, the reaction force acting on the battery cells from the central portions of the buffer members can be made smaller than the reaction force acting on the battery cells from the peripheral end portions of the buffer members. As a result, as in the above embodiments, when the battery cells 20 thermally expand, the reaction force acting on the battery cells 20 from the buffer members can be made substantially uniform at the central portions and the peripheral end portions, and there can be obtained advantageous effect that the thermal expansion of the battery cells 20 is absorbed by the buffer members.

Moreover, materials with different elastic moduli may be used for the central portions and the peripheral end portions of the buffer members. Specifically, by using for the material of the central portions of the buffer members a material whose elastic modulus is lower than that of the material used for the peripheral end portions, the reaction force acting on the battery cells from the central portions of the buffer members can be made smaller than the reaction force acting on the battery cells from the peripheral end portions of the buffer members as in the above embodiments.

The following supplemental notes are disclosed in relation to the above embodiments.

### (Supplemental Note 1)

A battery module comprising:
a plurality of battery cells housed in an arrayed state inside a case; and
a buffer member that is disposed at least one of between adjacent battery cells and between the battery cells and an inner wall of the case such that its thickness direction coincides with the array direction of the battery cells and is formed in such a way that a reaction force acting on the battery cells is smaller at its central portion than at its peripheral end portion.

### (Supplemental Note 2)

The battery module of supplemental note 1, wherein the buffer member is at least disposed in a central part of the case in the array direction of the battery cells.

### (Supplemental Note 3)

The battery module of supplemental note 1 or supplemental note 2, wherein the buffer member is formed such that the thickness of its central portion is thinner than that of its peripheral end portion.

### (Supplemental Note 4)

The battery module of any one of supplemental note 1 to supplemental note 3, wherein the buffer member is formed such that the density of its central portion is smaller than that of its peripheral end portion.

### (Supplemental Note 5)

The battery module of any one of supplemental note 1 to supplemental note 4, wherein the buffer member is at least disposed between inner walls on both sides of the case and the battery cells.

### (Supplemental Note 6)

The battery module of supplemental note 5, wherein disposed in a central part of the case in the array direction of the battery cells is a central thick buffer member formed such that the thickness of its central portion is thicker than that of its peripheral end portion.

### (Supplemental Note 7)

A battery pack comprising a plurality of the battery modules of any one of supplemental note 1 to supplemental note 6.

What is claimed is:

1. A battery module comprising:
a plurality of battery cells housed in an arrayed state inside a case; and
a buffer member that is disposed at least one of between adjacent battery cells or between the battery cells and an inner wall of the case such that a thickness direction of the buffer member coincides with an array direction of the battery cells, and that is formed in such a way that a reaction force acting on the battery cells is smaller at a central portion of the buffer member than at a peripheral end portion thereof.

2. The battery module of claim 1, wherein the buffer member is at least disposed at a central part of the case in the array direction of the battery cells.

3. The battery module of claim 1, wherein the buffer member is formed such that a thickness of a central portion thereof is thinner than that of a peripheral end portion thereof.

4. The battery module of claim 1, wherein the buffer member is formed such that a density of a central portion thereof is smaller than that of a peripheral end portion thereof.

5. The battery module of claim 1, wherein the buffer member is disposed at least between inner walls on both sides of the case and the battery cells.

6. The battery module of claim 5, wherein a central thick buffer member is disposed at a central part of the case in the array direction of the battery cells, the central thick buffer member being formed such that a thickness of a central portion thereof is thicker than that of a peripheral end portion thereof.

7. A battery pack comprising a plurality of battery modules of claim 1.
